(19) United States
(12) Patent Application Publication
(10) Pub. No.: US 2007/0233880 A1
(43) Pub. Date: Oct. 4, 2007

(54) Methods, media and systems for enabling a consistent web browsing session on different digital processing devices

(75) Inventors: Jason Nieh, New York, NY (US); Shaya J. Potter, New York, NY (US); Oren Laadan, New York, NY (US)

Correspondence Address: WilmerHale/Columbia University, 399 PARK AVENUE, NEW YORK, NY, 10022, US

(73) Assignee: THE TRUSTEES OF COLUMBIA UNIVERSITY IN THE CITY OF NEW YORK, New York, NY (US)

(21) Appl. No.: 11/584,314

(22) Filed: Oct. 20, 2006

Related U.S. Application Data
(60) Provisional application No. 60/729,093, filed on Oct. 20, 2005.
(60) Provisional application No. 60/729,095, filed on Oct. 20, 2005.
(60) Provisional application No. 60/729,094, filed on Oct. 20, 2005.

(51) Int. Cl. G06F 15/16

(52) U.S. Cl. 709/227

(57) ABSTRACT

Methods, media and systems for enabling a consistent web browsing session on different digital processing devices are provided. In some embodiments, a method includes storing data relating to one or more virtualized processes associated with a web browsing session on a first digital processing device in a storage device; connecting the storage device to a second digital processing device running an operating system; and restarting the one or more virtualized processes in the operating system of the second digital processing device using the stored data.

### CROSS-REFERENCE TO RELATED APPLICATIONS

This application claims priority under 35 U.S.C. § 119(e) from U.S. Provisional Application No. 60/729,094, filed on Oct. 20, 2005, U.S. Provisional Application No. 60/729,093, filed on Oct. 20, 2005, and U.S. Provisional Application No. 60/729,095, filed on Oct. 20, 2005, which are hereby incorporated by reference in their entireties.

### STATEMENT REGARDING FEDERALLY SPONSORED RESEARCH OR DEVELOPMENT

The government may have certain rights in the present invention pursuant to grants by National Science Foundation, grant numbers ANI-0240525 and CNS-0426623.

### TECHNOLOGY AREA

The disclosed subject matter relates to methods, media and systems for enabling a consistent web browsing session on different digital processing devices.

### BACKGROUND

As computers have become faster, cheaper, they have become ubiquitous in academic, corporate, and government organizations. At the same time, the widespread use of computers has given rise to enormous management complexity and security hazards, and the total cost of owning and maintaining them is becoming unmanageable. The fact that computers are increasingly networked complicates the management problem.

Computer users who make use of computers at different locations (e.g., home, school and work) lack a common computing environment as they move around. Computers at different locations and mobile computing devices such as cell phones and Personal Digital Assistants (PDAs) can be configured differently. For example, they can have different sets of software installed, which may make it difficult for a user to complete a task as the necessary software might not be available when the user moves to a different location or starts to use another computer or computing device. Similarly, mobile users want consistent access to their files, which is difficult to guarantee as they move around.

Given the ubiquity of web browsers on modern computers, many traditional applications are becoming web-enabled. Common applications such as e-mail and instant messaging have been ported to a web services environment that is usable from within a simple web browser. The advantage of this approach is that users effectively store their data on centrally managed servers that can be accessed on any networked computer. However, even by making applications accessible from a web browser, users are still constrained in their ability to browse effectively from any computer because of important missing data commonly stored in web browsers. This data can include bookmarks, cookies, and browser history, which records a state of usage and enable web browsers to function in a much more useful manner. The problem that occurs when a user moves between computers is that this data, which is specific to a web browser installation, cannot move with the user. Therefore, it is desirable to provide users with a consistent web browsing environment across different computers.

### SUMMARY

Methods, media and systems for enabling a consistent web browsing session on different digital processing devices are provided. Digital processing devices can include, for example, computers, set-top boxes, mobile computing devices such as cell phones and PDAs, and other embedded systems. In some embodiments, methods for enabling a consistent web browsing session on different digital processing devices are provided, comprising: storing data relating to one or more virtualized processes associated with a web browsing session on a first digital processing device in a storage device; connecting the storage device to a second digital processing device running an operating system; and restarting the one or more virtualized processes in the operating system of the second digital processing device using the stored data.

In some embodiments, computer-readable media containing computer-executable instructions that, when executed by a processor, cause the processor to perform a method for enabling a consistent web browsing session on different digital processing devices are provided, the method comprising: running one or more virtualized processes associated with a web browsing session in a first digital processing device; storing data relating to one or more virtualized processes in a storage device; and restarting the one or more virtualized processes in a second digital processing device using the stored data.

In some embodiments, systems for enabling a consistent web browsing session on different digital processing devices are provided, comprising: a storage device; a first digital processing device configured to store data relating to one or more virtualized processes associated with a web browsing session in the storage device; and a second digital processing device configured to restart the one or more virtualized processes using the stored data.

### BRIEF DESCRIPTION OF THE DRAWINGS

The Detailed Description, including the description of various embodiments of the invention, will be best understood when read in reference to the accompanying figures wherein:

FIG. 1 is a block diagram illustrating an operating system virtualization scheme according to some embodiments;

FIG. 2 is a diagram illustrating a method for enabling a consistent web browsing session according to some embodiments; and

FIG. 3 is a block diagram illustrating a system according to some embodiments.

### DETAILED DESCRIPTION

Methods, media and systems for enabling a consistent web browsing session on different digital processing devices are provided. In some embodiments, a web browsing session, including related processes and states, can be stored in a portable device and migrated to various host systems. In some embodiments, a virtualized operating system environment can be used to migrate applications in a flexible manner.

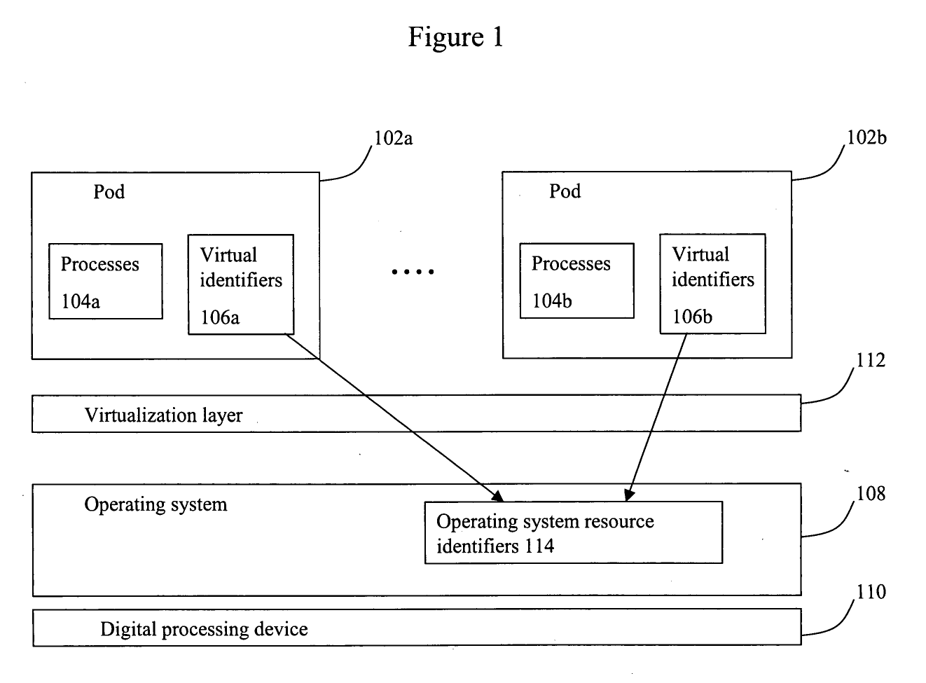

FIG. 1 is a block diagram illustrating an operating system virtualization scheme in some embodiments. An operating system 108 that runs on digital processing device 110 can be provided with a virtualization layer 112 that provides a PrOcess Domain (pod) abstraction. Digital processing device 110 can include, for example, computers, set-top boxes, mobile computing devices such as cell phones and Personal Ditigal Assistants (PDAs), other embedded systems and/or any other suitable device. One or more pods, for example, Pod 102a and Pod 102b, can be supported. A pod (e.g., pod 102a) can include a group of processes (e.g., processes 104a) with a private namespace, which can include a group of virtual identifiers (e.g., identifiers 106a). The private namespace can present the process group with a virtualized view of the operating system 108. This virtualization provided by virtualization layer 112 can associate virtual identifiers (e.g., identifiers 106a) with operating system resources identifiers 114 such as process identifiers and network addresses. Hence, processes (e.g., processes 104a) in a pod (e.g., pod 102a) can be decoupled from dependencies on the operating system 108 and from other processes (e.g., processes 104b) in the system. This virtualization can be integrated with a checkpoint-restart mechanism that enables processes within a pod to be migrated as a unit to another machine. This virtualization scheme can be implemented to virtualize any suitable operating systems, including, but not limited to, Unix, Linux, and Windows operating systems. This virtualization scheme can be, for example, implemented as a loadable kernel module in Linux.

The private, virtual namespace of pods enables secure isolation of applications by providing complete mediation to operating system resources. Pods can restrict what operating system resources are accessible within a pod by simply not providing identifiers to such resources within its namespace. A pod only needs to provide access to resources that are needed for running those processes within the pod. It does not need to provide access to all resources to support a complete operating system environment. An administrator can configure a pod in the same way one configures and installs applications on a regular machine. Pods enforce secure isolation to prevent exploited pods from being used to attack the underlying host or other pods on the system. Similarly, the secure isolation allows one to run multiple pods from different organizations, with different sets of users and administrators on a single host, while retaining the semantic of multiple distinct and individually managed machines.

For example, to provide a web server, a web server pod can be setup to only contain the files the web server needs to run and the content it wants to serve. The web server pod could have its own IP address, decoupling its network presence from the underlying system. The pod can have its network access limited to client-initiated connections using firewall software to restrict connections to the pod's IP address to only the ports served by applications running within this pod. If the web server application is compromised, the pod limits the ability of an attacker to further harm the system because the only resources he has access to are the ones explicitly needed by the service. The attacker cannot use the pod to directly initiate connections to other systems to attack them since the pod is limited to client-initiated connections. Furthermore, there is no need to carefully disable other network services commonly enabled by the operating system to protect against the compromised pod because those services, and the core operating system itself, reside outside of the pod's context.

Pod virtualization can be provided using a system call interposition mechanism and the chroot utility with file system stacking. Each pod can be provided with its own file system namespace that can be separate from the regular host file system. While chroot can give a set of processes a virtualized file system namespace, there may be ways to break out of the environment changed by the chroot utility, especially if the chroot system call is allowed to be used by processes in a pod. Pod file system virtualization can enforce the environment changed by the chroot utility and ensure that the pod's file system is only accessible to processes within the given pod by using a simple form of file system stacking to implement a barrier. File systems can provide a permission function that determines if a process can access a file.

For example, if a process tries to access a file a few directories below the current directory, the permission function is called on each directory as well as the file itself in order. If any of the calls determine that the process does not have permission on a directory, the chain of calls ends. Even if the permission function determines that the process has access to the file itself, it must have permission to traverse the directory hierarchy to the file to access it. Therefore, a barrier can be implemented by stacking a small pod-aware file system on top of the staging directory that overloads the underlying permission function to prevent processes running within the pod from accessing the parent directory of the staging directory, and to prevent processes running only on the host from accessing the staging directory. This effectively confines a process in a pod to the pod's file system by preventing it from ever walking past the pod's file system root.

Any suitable network file system, including Network File System (NFS), can be used with pods to support migration. Pods can take advantage of the user identifier (UID) security model in NFS to support multiple security domains on the same system running on the same operating system kernel. For example, since each pod can have its own private file system, each pod can have its own/etc/passwd file that determines its list of users and their corresponding UIDs. In NFS, the UID of a process determines what permissions it has in accessing a file.

Pod virtualization can keep process UIDs consistent across migration and keep process UIDs the same in the pod and operating system namespaces. However, because the pod file system is separate from the host file system, a process running in the pod is effectively running in a separate security domain from another process with the same UID that is running directly on the host system. Although both processes have the same UID, each process is only allowed to access files in its own file system namespace. Similarly, multiple pods can have processes running on the same system with the same UID, but each pod effectively provides a separate security domain since the pod file systems are separate from one another. The pod UID model supports an easy-to-use migration model when a user may be using a pod on a host in one administrative domain and then moves the pod to another. Even if the user has computer accounts in both administrative domains, it is unlikely that the user will have the same UID in both domains if they are administratively separate. Nevertheless, pods can enable the user to run the same pod with access to the same files in both domains.

Suppose the user has UID 100 on a machine in administrative domain A and starts a pod connecting to a file server residing in domain A. Suppose that all pod processes are then running with UID 100. When the user moves to a machine in administrative domain B where he has UID 200, he can migrate his pod to the new machine and continue running processes in the pod. Those processes can continue to run as UID 100 and continue to access the same set of files on the pod file server, even though the user's real UID has changed. This works, even if there's a regular user on the new machine with a UID of 100. While this example considers the case of having a pod with all processes running with the same UID, it is easy to see that the pod model supports pods that may have running processes with many different UIDs.

Because the root UID 0 may be privileged and treated specially by the operating system kernel, pod virtualization may treat UID 0 processes inside of a pod specially as well. This can prevent processes running with privilege from breaking the pod abstraction, accessing resources outside of the pod, and causing harm to the host system. While a pod can be configured for administrative reasons to allow full privileged access to the underlying system, there are pods for running application services that do not need to be used in this manner. Pods can provide restrictions on UID 0 processes to ensure that they function correctly inside of pods.

When a process is running in user space, its UID does not have any affect on process execution. Its UID only matters when it tries to access the underlying kernel via one of the kernel entry points, namely devices and system calls. Since a pod can already provide a virtual file system that includes a virtual/dev with a limited set of secure devices, the device entry point may already be secure. System calls of concern include those that could allow a root process to break the pod abstraction. They can be classified into three categories and are listed below:

Category 1: Host Only System Calls

mount—If a user within a pod is able to mount a file system, they could mount a file system with device nodes already present and thus would be able to access the underlying system directly. Therefore, pod processes may be prevented from using this system call.

stime, adjtimex—These system calls enable a privileged process to adjust the host's clock. If a user within a pod could call this system call they can cause a change on the host. Therefore pod processes may be prevented from using this system call.

acct—This system call sets what file on the host BSD process accounting information should be written to. As this is host specific functionality, processes may be prevented from using this system call.

swapon, swapoff—These system calls control swap space allocation. Since these system calls are host specific and may have no use within a pod, processes may be prevented from calling these system calls.

reboot—This system call can cause the system to reboot or change Ctrl-Alt-Delete functionality. Therefore, processes may be prevented from calling it.

ioperm, iopl—These system calls may enable a privileged process to gain direct access to underlying hardware resources. Since pod processes do not access hardware directly, processes may be prevented from making these system calls.

create_nodule, init_nodule, delete_nodule, query_module—These system calls relate to inserting and removing kernel modules. As this is a host specific function, processes may be prevented from making these system calls.

sethostname, setdomainname—These system call set the name for the underlying host. These system calls may be wrapped to save them with pod specific names, allowing each pod to call them independently.

nfsservctl—This system call can enable a privileged process inside a pod to change the host's internal NFS server. Processes may be prevented from making this system call.

Category 2: Root Squashed System Calls

nice, setpriority, sched_setscheduler—These system calls lets a process change its priority. If a process is running as root (UID 0), it can increase its priority and freeze out other processes on the system. Therefore, processes may be prevented from increasing their priorities.

ioctl—This system call is a syscall demultiplexer that enables kernel device drivers and subsystems to add their own functions that can be called from user space. However, as functionality can be exposed that enables root to access the underlying host, all system call beyond a limited audited safe set may be squashed to user “nobody,” similar to what NFS does.

setrlimit—this system call enables processes running as UID 0 to raise their resource limits beyond what was preset, thereby enabling them to disrupt other processes on the system by using too much resources. Processes may be prevented from using this system call to increase the resources available to them.

mlock, mlockall—These system calls enable a privileged process to pin an arbitrary amount of memory, thereby enabling a pod process to lock all of available memory and starve all the other processes on the host. Privileged processes may therefore be reduced to user “nobody” when they attempt to call this system call so that they are treated like a regular process.

Category 3: Option Checked System Calls

mknod—This system call enables a privileged user to make special files, such as pipes, sockets and devices as well as regular files. Since a privileged process needs to make use of such functionality, the system call cannot be disabled. However, if the process creates a device it may be creating an access point to the underlying host system. Therefore when a pod process makes use of this system call, the options may be checked to prevent it from creating a device special file, while allowing the other types through unimpeded.

The first class of system calls are those that only affect the host system and serve no purpose within a pod. Examples of these system calls include those that load and unload kernel modules or that reboot the host system. Because these system calls only affect the host, they would break the pod security abstraction by allowing processes within it to make system administrative changes to the host. System calls that are part of this class may therefore be made inaccessible by default to processes running within a pod.

The second class of system calls are those that are forced to run unprivileged. Just like NFS, pod virtualization may force privileged processes to act as the “nobody” user when they want to make use of some system calls. Examples of these system calls include those that set resource limits and ioctl system calls. Since system calls such as setrtimit and nice can allow a privileged process to increase its resource limits beyond predefined limits imposed on pod processes, privileged processes are by default treated as unprivileged when executing these system calls within a pod. Similarly, the ioctl system call is a system call multiplexer that allows any driver on the host to effectively install its own set of system calls. Pod virtualization may conservatively treat access to this system call as unprivileged by default.

The third class of system calls are calls that are required for regular applications to run, but have options that will give the processes access to underlying host resources, breaking the pod abstraction. Since these system calls are required by applications, the pod may check all their options to ensure that they are limited to resources that the pod has access to, making sure they are not used in a manner that breaks the pod abstraction. For example, the mknod system call can be used by privileged processes to make named pipes or files in certain application services. It is therefore desirable to make it available for use within a pod. However, it can also be used to create device nodes that provide access to the underlying host resources. To limit how the system call is used, the pod system call interposition mechanism may check the options of the system call and only allows it to continue if it is not trying to create a device.

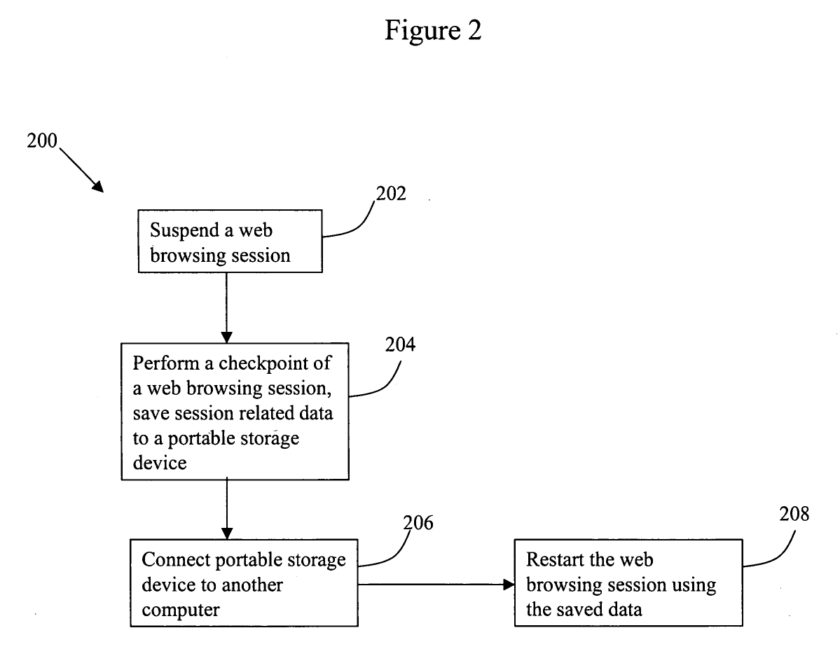

In some embodiments, checkpoint-restart as shown in FIG. 2 can allow pods to be migrated across machines running different operating system kernels. Upon completion of the upgrade process (e.g., at 210 of method 200), the system and its applications may be restored on the original machine. Pods can be migrated between machines with a common CPU architecture with kernel differences that may be limited to maintenance and security patches.

Many of the Linux kernel patches contain security vulnerability fixes, which are typically not separated out from other maintenance patches. Migration can be achieved where the application's execution semantics, such as how threads are implemented and how dynamic linking is done, do not change. On the Linux kernels, this is not an issue as all these semantics are enforced by user-space libraries. Whether one uses kernel or user threads, or how libraries are dynamically linked into a process can be determined by the respective libraries on the file system. Since the pod may have access to the same file system on whatever machine it is running on, these semantics can stay the same. To support migration across different kernels, a system can use a checkpoint-restart mechanism that employs an intermediate format to represent the state that needs to be saved on checkpoint, as discussed above.

In some embodiments, the checkpoint-restart mechanism can be structured to perform its operations when processes are in such a state that saving on checkpoint can avoid depending on many low-level kernel details. For example, semaphores typically have two kinds of state associated with each of them: the value of the semaphore and the wait queue of processes waiting to acquire the corresponding semaphore lock. In general, both of these pieces of information have to be saved and restored to accurately reconstruct the semaphore state. Semaphore values can be easily obtained and restored through GETALL and SETALL parameters of the semcti system call. But saving and restoring the wait queues involves manipulating kernel internals directly. The checkpoint-restart mechanism avoids having to save the wait queue information by requiring that all the processes be stopped before taking the checkpoint. When a process waiting on a semaphore receives a stop signal, the kernel immediately releases the process from the wait queue and returns EINTR. This ensures that the semaphore wait queues are always empty at the time of checkpoint so that they do not have to be saved.

While most process state information can be abstracted and manipulated in higher-level terms using higher-level kernel services, there are some parts that are not amenable to a portable intermediate representation. For instance, specific TCP connection states like time-stamp values and sequence numbers, which do not have a high-level semantic value, have to be saved and restored to maintain a TCP connection. As this internal representation can change, its state needs to be tracked across kernel versions and security patches. Fortunately, there is usually an easy way to interpret such changes across different kernels because networking standards such as TCP do not change often. Across all of the Linux 2.4 kernels, there was only one change in TCP state that required even a small modification in the migration mechanism. Specifically, in the Linux 2.4.14 kernel, an extra field was added to TCP connection state to address a flaw in the existing syncookie mechanism. If configured into the kernel, syncookies protect an Internet server against a synflood attack. When migrating from an earlier kernel to a Linux-2.4.14 or later version kernel, the extra field can be initialized in such a way that the integrity of the connection is maintained. In fact, this is the only instance across all of the Linux 2.4 kernel versions where an intermediate representation is not possible and the internal state had changed and had to be accounted for.

Various embodiments provide systems and methods that can enable mobile users to use the same persistent, personalized web browsing environment on Internet-enabled devices. A consistent browsing environment is maintained by storing in a portable storage device some or all of a user's plugins, bookmarks, browser web content, open browser windows, and browser configuration options and preferences. A virtualization and checkpoint-restart mechanism can be used to decouple the browsing environment from the host, enabling a web browsing session (which can include browsing related processes) to be suspended to portable storage, carried around, and resumed from the storage on another computer. In some embodiments, web browsing sessions are isolated from a host, protecting the browsing privacy of a user and preventing malicious web content from damaging the host.

FIG. 2 is diagram illustrating a method 200 for enabling a consistent web browsing session according to some embodiments. At 202, a web browsing session is suspended on a host system, i.e., processes related to the session are suspended. At 204, a checkpoint of a web browsing session can be performed, and session related data is saved in a portable storage device. The session related data may include state information of session related processes and other web browsing session data such as bookmarks and cookies. At 206, the portable device can be connected to another computer. At 208, the web browsing session can be restarted from the saved data.

To perform the checkpoint and restart operations in method 200, a user's web browsing session can be encapsulated in a virtualized execution environment. This virtualization can decouple web browsing sessions from the underlying operating system environment by introducing a private virtual namespace that can provide consistent, host-independent naming of system resources. Display of the session can also be virtualized so that a web browsing session can be scaled to different display resolutions that may be available as a user moves from one computer to another. This enables a web browsing session to run in the same way on any host despite differences that may exist among different host operating system environments and display hardware. Furthermore, this virtualization can protect the underlying host from untrusted applications that a user may run as part of a web browsing session. This virtualization can also prevent other applications from outside of the web browsing session that may be running on the host from accessing any of the session's data, protecting the browsing privacy of the user.

Checkpoint-restart as shown in FIG. 2 enables a user to suspend the entire web browsing session to the portable storage device so that it can be migrated between physical computers by simply moving the device to a new computer and resuming the session there. File system state as well as process execution state associated with the web browsing session can be preserved on the portable storage device.

Therefore, users can maintain a common web browsing environment no matter what computer they are using. Users can easily carry their web browser sessions with them, without lugging around a bulky laptop or being restricted to a more portable device without sufficient display size. In some embodiments, web browser helper applications and plug-ins that users need can always be made available without reliance on application resources of the underlying host machine. A user's cookies, bookmarks, and other browser state can be constantly available as they are stored within the web browsing session. Because of a fast checkpoint-restart mechanism, users can quickly save their entire web browsing environment when they have to change locations, without the need to manually attempt to save all the individual elements of their state. Mobile users can simply unplug the portable storage device from the computer, move onto a new computer and plug in, and restart their session from the portable storage device to pick up where they left off. These functionalities can be provided without modifying, recompiling or relinking any applications or the operating system kernel, and with only a negligible performance impact.

The portable storage device can be any suitable device, e.g., one that can easily fit in a user's pocket yet store large amounts of data. Such storage devices range from flash memory sticks, that can hold 1 GB of data, to Apple ipods, that can hold 60 GB of data. A user session can be populated with the complete set of applications used in a user's normal web browsing environment so that the environment is available on any computer. To the user, a web browsing session can appear no different than using a private computer even though the session runs on a host that may be running other applications. Those applications running outside of the web browsing session can be made invisible to a user within the session. To provide strong security, the device can store session related data on an encrypted file system. Therefore, even if the device is lost or stolen, an attacker will just be able to use it as his own personal storage device.

In method 200, to restart a web browsing session at 208, a user can simply plug the portable storage device into a computer. The computer detects the device and can automatically restart the web browsing session. This can involve first authenticating the user by asking for a password. Authentication can also be done without passwords by using biometric technology in the form of built-in fingerprint readers available on some USB drives. Once a user is authorized, an encrypted file system for the portable storage device can be mounted and the web browsing session can be restarted. A viewer can be attached to the session to make the associated set of web browser windows available and visible to the user. Applications running in a web browsing session appear to the underlying operating system just like other applications that may be running on the host machine, and they can make use of the host's network interface in the same manner.

Once a web browsing session is started, a user can commence web browsing using the available web browsing environment. When the user wants to leave the computer, the user may close the viewer. This can cause the web browsing session to be quickly saved to the portable storage device as a checkpoint, which can then be unplugged and carried around by the user. When another computer is ready to be used, the user simply plugs in the device and the session is restarted right where it left off. There is no need for a user to manually launch the web browser, reopen web browser windows, and reload web content.

A portable storage device can be simpler than a traditional computer in that it only provides a web browsing application environment, not an entire operating system environment. An operating system does not need to be installed on the portable storage device. The portable storage device can instead make use of the operating system environment available on the host computer into which it is plugged in. This provides two important benefits for users in terms of startup speed and management complexity. Because there may be no operating system on the portable storage device, there is no need to boot a new operating system environment or attempt to configure an operating system to operate on the particular host machine that is being used. Since only web browsing related applications need to be restarted, startup costs can be minimized. This also ensures that a portable storage device can be used on any machine on which a compatible operating system is running. Furthermore, there is no need for users to maintain and manage an operating system environment, reducing management complexity.

Web browsing sessions can be protected by isolating each session in its own private execution environment. Other user-level applications running on the same machine may not be able to access any state associated with a web browsing session, protecting the browsing privacy of users. If a portable storage device is lost, the user can lose browser state such as bookmarks and cookies, but important user data stored by web services on centrally managed servers may not be lost. In addition, a web browsing state can be encrypted on the portable storage device to minimize the damage suffered if the device is lost or stolen. To reduce the risk of browser data loss further, a portable storage device can be backed up periodically when it returns to the user's own computer, in the same manner as a user synchronizes a Personal Digital Assistant (PDA). Alternatively, a portable storage device can be incrementally backed up automatically using a network backup service whenever it is plugged in to a networked computer. Backup can be performed when the web browsing session is not actively being used to avoid impacting the user's browsing experience. In either case, if a portable storage device is lost, the user's web browsing session can be easily restored from backup onto another device.

To provide a private and mobile execution environment for web browsing sessions, underlying host operating system and display can be virtualized. This virtualization can enable web browsing sessions to be decoupled from the underlying host on which it is being executed. This allows browsing related applications to be isolated from the underlying system and other applications, to be saved on one machine and restarted on another, and to be displayed on hosts with different display hardware and display resolution. Given the large existing base of web applications and commodity operating systems, this virtualization can be designed to be completely transparent to work with existing unmodified applications and operating system kernels.

The underlying host operating system can be virtualized by encapsulating web browsing sessions within a host independent, virtualized view of the operating system. Each web browsing session can be provided with its own virtual private namespace. For example, a web browsing session can contain its own host independent view of operating system resources, such as process identifier (PID), group identifier (GID), interprocess communication (IPC), memory, file system, and devices. The namespace can be made to be the only means for the processes associated with running web browsing application instances to access the underlying operating system. This namespace can therefore decouple processes associated with applications running in web browsing sessions from the underlying host operating system.

In various embodiments, the namespace is private in that only processes within the session can see the namespace, and the namespace in turn can mask out resources that are not contained in the session. Processes inside the session can appear to one another as normal processes, and they can communicate using traditional IPC mechanisms. On the other hand, IPC interaction may be prevented from occurring across the session's boundary, because outside processes on the host are not part of the private namespace. Processes inside a session, and those outside of it, may only be permitted to communicate using remote procedure call (RPC) mechanisms, traditionally used to communicate across computers. As a result, processes within the namespace can be isolated from processes outside of the namespace as though those within the namespace were running on a private computer.

The namespace can be virtual in that all operating system resources, including processes, user information, files, and devices, can be accessed through virtual identifiers. Virtual identifiers can be distinct from the host-dependent, physical resource identifiers used by the operating system. The session's namespace uses virtual identifiers to provide a host-independent view of the system, which can remain consistent throughout a process' and session's lifetime. Because the session's namespace is separate from the underlying host namespace, it can preserve naming consistency for its processes, even in the presence of changes to the underlying operating system.

The namespace enables browsing related processes to be isolated from the host system, saved to its portable storage device, and transparently restarted on another machine, as shown in FIG. 2. The private virtual namespace can provide consistent, virtual resource names for browsing related processes to enable web browsing sessions to migrate from one machine to another. Names within a session can be trivially assigned in a unique manner in the same way that traditional operating systems assign names, but such names are localized to the session. Because the namespace is virtual, there is no need for it to change when the session is migrated, ensuring that identifiers remain constant throughout the life of the process, as required by applications that use such identifiers. Because the namespace is private to the web browsing session, processes within the session can be migrated as a group, while avoiding resource naming conflicts among other processes running on the host.

The private virtual namespace can also enable the web browsing session to be securely isolated from the host by providing complete mediation to all operating system resources. Because the only resources within the web browsing session are the ones that are accessible to the owner of the session, a compromised session is limited in its ability to affect any activities running on the host outside of the session. Similarly, because any attempts by processes outside of the session to interact with processes running inside of the session must also occur through operating system resources, those interactions can be filtered out as well.

Operating system instance can be virtualized by using mechanisms that translate between the session's virtual resource identifiers and the operating system resource identifiers. A system call interposition mechanism can be used to virtualize operating system resources, including process identifiers, keys and identifiers for IPC mechanisms such as semaphores, shared memory, and message queues, and network addresses. In Linux, for example, the chroot utility and file system stacking can be used to provide each session with its own file system namespace. Each session can be provided with its own file system namespace. A web browsing session's file system can be totally contained within a portable storage device, which guarantees that the same files can be made consistently available as the session is migrated from one computer to another. More specifically, when a web browsing session is created or restarted on a host, a private directory can be created in the host. This directory can serve as a staging area for the session's virtual file system. Within the directory, the session's file system can be mounted from the device. The chroot system call can then be used to set the staging area as the root directory for the session, thereby achieving file system virtualization with negligible performance overhead. This method of file system virtualization can provide an easy way to restrict access to files and devices from within a session. This can be done by simply not including file hierarchies and devices within the session's file system namespace. If files and devices are not mounted within the session's virtual file system, they are not accessible to the session's processes.

Commodity operating systems are not built to support multiple namespaces securely. File system virtualization must address the fact that there are multiple ways to break out of an environment changed by the chroot system call, especially when the chroot system call is allowed to be used in a session. However, embodiments of the present invention can provide security by disallowing the privileged root user from being used within the session. The web browsing session's file system virtualization can also enforce the environment changed by the chroot system call and ensure that the session's file system are the only files accessible to processes within session, by using a simple form of file system stacking to implement a barrier. This barrier directory can prevent processes within the session from traversing it. Because the processes are not allowed to traverse the directory, they are unable to access files outside of the session's file system namespace. Therefore, by combining the inability for web browsing related processes to access any files outside of the portable storage device's file system, as well as the inability for the processes to run with privilege, the processes can be confined to the web browsing session and can't affect change on the host system.

Maintaining a user web browsing session across different computing systems requires redisplaying the session on the different systems. With conventional computer systems, graphical applications such as web browsers display their output to a window system, which then processes the display commands to a video device driver to be rendered to the computer's framebuffer so that images appear on the computer's screen. The display state associated with an application is distributed at different times between the window system and the hardware framebuffer. If an application is to be moved from one computer to another, it is important that all of its display state be captured so that the application can be properly redisplayed on the destination system. However, a window system may contain display state for many applications. Therefore, identifying and extracting the display state for a particular application in an application transparent manner can be difficult. Because framebuffer hardware varies from one system to another, extracting the display state for a particular application from a particular framebuffer in a manner that is portable across different systems can also be difficult given that such state is often tied closely to the specifics of the particular physical display device used.

According to various embodiments, a display virtualization mechanism may be used to virtualize the display associated with a web browsing session, so that the session can be viewed on different hosts that may have different display systems available. Virtualization can provide each web browsing session with its own virtual display server and virtual device driver to decouple the display of the web browsing session from the display subsystem of the host. The virtual display server can provide a web browsing session with its own window system separate from the window system on the host, thereby separating browsing related application display state from other applications running on the host outside of the web browsing session. The display server can be considered a part of the web browsing session and is saved as a checkpoint when the web browsing session is suspended and restarted when the web browsing session is resumed. In one embodiment, an XFree86 4.3 server can be used as the display server.

Instead of rendering display commands to a real device driver associated with a physical display device on the host, a virtual display server can direct its commands to a virtual device driver representing a virtual display device associated with the web browsing session. The virtual display device can process display commands and directs its output to memory instead of a framebuffer. This approach abstracts away the specific implementation of video card features into a high level view that is applicable to all video cards. Because the device state is not in the physical device but in the virtualized web browsing session, display state management during checkpoint-restart of a web browsing session is simplified. As a result, saving the display state as a checkpoint can be performed by simply saving the associated memory instead of extracting display state from the host-specific framebuffer.

In some embodiments, a virtual display device can use a video hardware layer approach, which can allow it to take full advantage of existing infrastructure and hardware interfaces while maximizing host resources and requiring minimal computation on the host. Furthermore, new video hardware features can be supported with at most the same amount of work necessary for supporting them in traditional desktop display drivers. While there is some loss of semantic display information at the low-level video device driver interface, experiments with web applications indicate that the vast majority of application display commands issued can be mapped directly to standard video hardware primitives. In some embodiments, direct video support can be provided by leveraging alternative YUV video formats natively supported by most off-the-shelf video cards available. Video data can simply be transferred from the virtual display driver to the host's video hardware, which can automatically perform inexpensive, high speed, color space conversion and scaling.

Rather than sending display commands to local display hardware, a virtual video driver can package up display commands associated with a user's computing session, write them to memory, and enable them to be viewed using a viewer application that runs in the context of the window system on the host. The viewer application can be completely decoupled from the rest of the web browsing related display mechanism. The viewer can read the persistent display state managed by the web browsing related display mechanism. The viewer can be disconnected and reconnected to the web browsing session at any time without loss of display information since it does not maintain any persistent display state.

The above-described display mechanism can be designed so that a session can be viewed from multiple locations at the same time. While it is being viewed on the local host in which the portable storage device is plugged in, it can be shared with another user running a viewer application on a remote host. This facilitates collaboration among users. To allow web browsing sessions to be viewed locally or across a network, a simple, low-level, minimum-overhead display protocol can be implemented. The protocol can mimic the operations most commonly found in display hardware, allowing the host to do little more than take protocol commands sent from a web browsing session to a viewer and forward them to their local video hardware to be displayed, thus reducing the latency of display processing. To support host devices that can support varying resolutions, this protocol can allow the viewer application to be resolution independent and can scale the display appropriately.

Checkpoint and restart of a web browsing session as shown in FIG. 2 can be performed on computers with different hardware and operating system kernels. A web browsing session can be migrated between machines with a common CPU architecture, and where kernel differences are limited to maintenance and security patches. Migration can also be achieved in scenarios where the application's execution semantics, such as how threads are implemented or dynamic linking is performed, stay constant. On the Linux kernel, for example, these semantics are enforced by user-space libraries. Because the session's user-space libraries can migrate with the session, the semantics can stay constant.

To migrate a web browsing session across different kernels, the checkpoint-restart mechanism can use an intermediate format to represent the state that needs to be saved. Although the internal state that the kernel maintains on behalf of processes can be different across kernels, the high-level properties of the process are much less likely to change. The checkpoint-restart mechanism can capture the state of a process in terms of this higher-level semantic information rather than the kernel specific data. For example, this information may include part of the state associated with a Unix socket connection including the directory entry of the socket, its superblock information, and a hash key. All of this state can be saved in this form and successfully restored on a different machine running the same kernel. But to support migration across different kernels, a high-level representation including a four tuple, {virtual source process identifier, source file descriptor, virtual destination process identifier, destination file descriptor}, can be used. This is because the semantics of a process identifier and a file descriptor are standard across different kernels.

An intermediate representation format can be chosen such that it offers the degree of portability needed for migrating between different kernel minor versions. If the representation of state is too high-level, the checkpoint-restart mechanism can become complicated and impose additional overhead. For example, the checkpoint-restart mechanism can save the address space of a process in terms of discrete memory regions called Virtual Machine (VM) areas. As an alternative, it can save the contents of a process' address space and denote the characteristics of various portions of it in more abstract terms. The VM area abstraction may be standard even across major Linux kernel revisions.

In some embodiments, high-level native kernel services can be used to transform the intermediate representation of the check-pointed image into the complete internal state required by the target kernel. Continuing with the previous example, the checkpoint-restart mechanism can restore a Unix socket connection using high-level kernel functions as follows. First, two new processes can be created with virtual process identifiers as specified in the four tuple. Then, each one can create a Unix socket with the specified file descriptor and one socket can be made to connect to the other. This effectively recreates the original Unix socket connection without depending on many internal kernel details.

Security patches and minor version kernel revisions commonly involve modifying the internal details of the kernel while high-level primitives remain unchanged. As such, high-level functions are usually made available to kernel modules through exported kernel symbol interfaces. Therefore, the checkpoint-restart mechanism may be able to perform cross-kernel migration without requiring modifications to the kernel.

To eliminate possible dependencies on low-level kernel details, the checkpoint-restart mechanism can require processes to be suspended prior to being saved as a checkpoint. Suspending processes can create a quiescent state necessary to guarantee the correctness of the saved image, and it also minimizes the amount of information that needs to be saved. As a representative example, consider the case of semaphore wait queues. Although semaphore values can be easily obtained and restored through well known interfaces, saving and restoring the state of the wait queue involves the manipulation of kernel internals. However, by taking advantage of existing semantics that direct the kernel to release a process from a wait queue upon receipt of a signal, a system is able to empty the wait queues by suspending all processes, and therefore avoid having to save the state of the queue.

Because processes within a web browsing session may only have access to devices through the virtual device drivers provided, it is simple to save the device specific data associated with the processes. In particular, since the browsing related display mechanism can be built using its own virtual display device driver that is not tied to any specific hardware device, such virtual device state can be more easily saved as a checkpoint. Because the virtual device state can be totally stored in regular memory, it's a simple matter of saving that state on checkpoint and restoring it on restart. When the viewer application on the host reconnects to the virtual display driver, it is able to display the complete display.

Checkpoint-restart as shown in FIG. 2 can preserve all application state necessary to restart the application at a later time in exactly the same state as it was when it was saved. In some embodiments, however, the checkpoint-restart mechanism may not preserve open network connections as part of its saved state and closes all open network connections before it saves the browsing session. When the session is restarted, web applications will need to reconnect to the appropriate servers as opposed to reusing previous connections. However, the need to reestablish network connections may not result in any user-perceived differences for most web applications. Web browsers were originally designed using HTTP 1.0 without persistent connections, so that browsers frequently reconnect to web servers during normal operation. While persistent HTTP connections are known to provide better performance, most users are completely oblivious to whether persistent or nonpersistent connections are used. Therefore, although additional infrastructure can be used to preserve open network connections during migration, the checkpoint-restart mechanism may be designed differently given the ability of web applications to easily reestablish network connections without any user-perceived changes in application behavior.

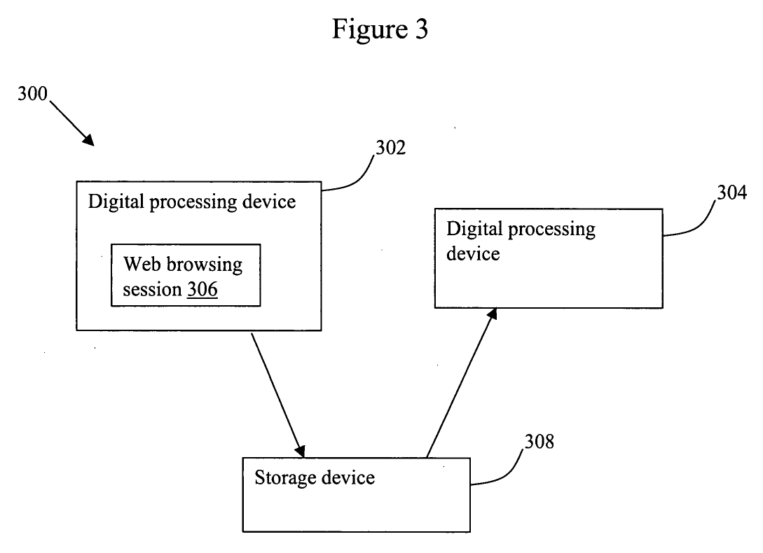

FIG. 3 is a block diagram depicting a system 300 according to some embodiments. As shown, digital processing device 302 can be used to provide web browsing session 306. Data relating to the web browsing session can be stored in storage device 308. When storage device 308 is connected to another digital processing device 304, data stored in storage device can be used to recreate web browsing session 306 in digital processing device 304. Storage device 308 can be a portable storage device, so that a user can bring the stored data to different locations. Storage device 308 can also be a networked storage device, so that networked digital processing devices can retrieve the stored data from storage device 308 using a network connection.

Although some examples presented above relate to the Linux operating system, it will be apparent to a person skilled in the field that various embodiments can be implemented and/or used with any other operating systems, including, but not limited to, Unix and Windows operating systems. In addition, various embodiments are not limited to be used with computers, but can be used with any suitable digital processing devices. Digital processing devices can include, for example, computers, set-top boxes, mobile computing devices such as cell phones and Personal Ditigal Assistants (PDAs), other embedded systems, and/or any other suitable device.

Other embodiments, extensions, and modifications of the ideas presented above are comprehended and within the reach of one skilled in the field upon reviewing the present disclosure. Accordingly, the scope of the present invention in its various aspects is not to be limited by the examples and embodiments presented above. The individual aspects of the present invention, and the entirety of the invention are to be regarded so as to allow for modifications and future developments within the scope of the present disclosure. The present invention is limited only by the claims that follow.

What is claimed is:

1. A method for enabling a consistent web browsing session on different digital processing devices, comprising:
storing data relating to one or more virtualized processes associated with a web browsing session on a first digital processing device in a storage device;
connecting the storage device to a second digital processing device running an operating system; and
restarting the one or more virtualized processes in the operating system of the second digital processing device using the stored data.

2. The method of claim 1, further comprising storing a plug-in application.

3. The method of claim 1, further comprising suspending the one or more processes before storing data relating to the one or more virtualized processes.

4. The method of claim 1, further comprising storing web browsing session data comprising at least one of a browser option, a browser bookmark, a brower cookie, browser history, web content, and user entered data.

5. The method of claim 4, further comprising encrypting the web browsing session data.

6. The method of claim 1, further comprising generating a display state of the web browsing session, the display state being independent of processes unrelated to the web browsing session running on the first digital processing device.

7. The method of claim 6, further comprising storing the display state of the web browsing session in the storage device.

8. The method of claim 6, further comprising sending the display state to a viewer application to be displayed in the viewer application.

9. The method of claim 1, further comprising authenticating a user at the second digital processing device.

10. A computer-readable medium containing computer-executable instructions that, when executed by a processor, cause the processor to perform a method for enabling a consistent web browsing session on different digital processing devices, comprising:
running one or more virtualized processes associated with a web browsing session in a first digital processing device;
storing data relating to the one or more virtualized processes in a storage device; and
restarting the one or more virtualized processes in a second digital processing device using the stored data.

11. The computer-readable medium of claim 10, the method further comprising storing a plug-in application.

12. The computer-readable medium of claim 10, the method further comprising suspending the one or more processes before storing data relating to the one or more virtualized processes.

13. The computer-readable medium of claim 10, the method further comprising storing web browsing session data comprising at least one of a browser option, a browser bookmark, a brower cookie, browser history, web content, and user entered data.

14. The computer-readable medium of claim 13, the method further comprising encrypting the web browsing session data.

15. The computer-readable medium of claim 10, the method further comprising generating a display state of the web browsing session, the display state being independent of processes unrelated to the web browsing session running on the first digital processing device.

16. The computer-readable medium of claim 15, the method further comprising storing the display state of the web browsing session in the storage device.

17. The computer-readable medium of claim 15, the method further comprising sending the display state to a viewer application to be displayed in the viewer application.

18. The computer-readable medium of claim 10, further comprising authenticating a user at the second digital processing device.

19. A system for enabling a consistent web browsing session on different digital processing devices, comprising:
a storage device;
a first digital processing device configured to store data relating to one or more virtualized processes associated with a web browsing session in the storage device; and
a second digital processing device configured to restart the one or more virtualized processes using the stored data.

20. The system of claim 19, wherein the storage device is a portable storage device.

21. The system of claim 19, wherein the storage device is a networked storage device connected to the first digital processing device and the second digital processing device.
